(19) United States
(12) Patent Application Publication
(10) Pub. No.: US 2025/0165793 A1
(43) Pub. Date: May 22, 2025

(54) ALGORITHM SYSTEM OF DEEP REINFORCEMENT LEARNING AND ALGORITHM METHOD THEREOF

(71) Applicant: Industrial Technology Research Institute, Hsinchu (TW)

(72) Inventors: Chia-Hsiang Yang, Taipei City (TW); Shih-Hao Chen, Taipei City (TW); Chih-Wei Liu, Hsinchu County (TW)

(73) Assignee: Industrial Technology Research Institute, Hsinchu (TW)

(21) Appl. No.: 18/393,464

(22) Filed: Dec. 21, 2023

(30) Foreign Application Priority Data
Nov. 17, 2023 (TW) 112144444

(51) Int. Cl. G06N 3/092

(52) U.S. Cl. CPC G06N 3/092

(57) ABSTRACT

An algorithm method for deep reinforcement learning includes initializing an environment and a model; executing an experience collection process and a network update process in parallel, and determining whether the experience collection process and the network update process have reached a termination condition; and continuing executing the experience collection process and the network update process in parallel in response to neither of the experience collection process and the network update processes has met the termination conditions; and stopping executing the experience collection process and the network update process in response to one of the experience collection processes and the network update process having met the termination conditions. The experience collection process includes obtaining a current state of the environment; calculating to determine the current action based on the current observation values according to a current policy of the model; and returning the current action to the environment.

### CROSS-REFERENCE TO RELATED APPLICATION

This application claims the priority benefit of Taiwan application serial no. 112144444, filed on Nov. 17, 2023. The entirety of the above-mentioned patent application is hereby incorporated by reference herein and made a part of this specification.

### TECHNICAL FIELD

The present disclosure relates to a calculation technology, and in particular to an algorithm system of deep reinforcement learning and an algorithm method thereof.

### BACKGROUND

Nowadays, the algorithm of deep reinforcement learning in the field of artificial intelligence is commonly adopted in machine vision and industrial robot arms. Reinforcement learning is a machine learning technology that is characterized by its ability to autonomously explore an unknown environment and train an intelligent agent model that is able to complete multi-step decision-making actions to solve problems. The intelligent agent will take actions based on observation of the state of the current environment and receive a reward feedback. The intelligent agent will gradually update the policy of selecting actions based on the obtained reward information to maximize the rewards obtained in the environment.

Specifically, reinforcement learning involves two different steps: experience collection and network update. In the experience collection step, it is necessary to evaluate the input information of the environment based on the current policy to determine the next action to be performed in the environment; while in the network update step, algorithm is performed based on the data previously collected in the environment to update the policy of the current model. The experience collection step requires inference algorithm, and the network update step requires training algorithm.

Currently, existing deep reinforcement learning accelerators normally adopt the same set of computing resources to support training and inference, but only one of training and inference can be processed at a time, and therefore the two steps in deep reinforcement learning have to be performed by turns. Specifically, in the inference phase, the encountered problem is small number of batches and the need to wait for the environment to respond, which causes low hardware utilization and long delay time. Accordingly, the existing architecture takes a long time to execute the overall reinforcement learning algorithm. Therefore, how to solve the problem that existing deep reinforcement learning accelerators can only handle training or inference at a time, which results in long delays, will be an issue that requires a solution.

### SUMMARY

The present disclosure provides an algorithm system for deep reinforcement learning, including: a memory, an input/output interface, and a processor. The memory is disposed to store the previous state of the environment, the previous policy of the model, inference programs, and training programs. The processor is coupled to the memory and the input/output interface to perform initialization of the environment and the model through the input/output interface; read the inference program and the training program from the memory, wherein the inference program corresponds to the experience collection process and the training program corresponds to the network update process; execute the experience collection process and the network update process in parallel, and determine whether the experience collection process and the network update process meet the termination condition; continue executing the experience collection process and the network update process in parallel in response to neither of the experience collection process and the network update processes has met the termination condition; and stopping executing the experience collection process and the network update process in response to one of the experience collection processes and the network update process having met the termination condition. The experience collection process includes obtaining a current state of the environment through the input/output interface; wherein the current state includes current reward values and current observation values; calculating to determine the current action based on the current observation values according to a current policy of the model; and returning the current action to the environment through the input/output interface. The network update process includes obtaining a previous state of the environment and a previous policy of the model from the memory, wherein the previous state includes a previous action, a previous reward value, and a previous observation value; calculating based on the previous state to determine current data; and updating the previous policy of the model to the current policy based on the current data.

In an embodiment, the processor further includes an inference processing module and a training processing module. The inference processing module is disposed to read the inference program from the memory and execute the experience collection process; the training processing module is disposed to read the training program from the memory and execute the network update process.

In an embodiment, when the processor executes the experience collection process, the processor is further disposed to: determine whether the number of executions of the experience collection process reaches the execution number threshold; and determine that the experience collection process reaches the termination condition in response to the number of executions reaching the execution number threshold.

In an embodiment, when the processor executes the network update process, the processor is further disposed to: determine whether the number of executions of the network update process reaches the execution number threshold; and determine that the network update process reaches the termination condition in response to the number of executions reaching the execution number threshold.

In an embodiment, when the processor executes the experience collection process, the processor is further disposed to: after the environment receives the current action through the input/output interface, determine whether the success rate corresponding to the current state of the environment reaches a success rate threshold; and determine that the experience collection process reaches a termination condition in response to the success rate reaching the success rate threshold.

In an embodiment, when the processor executes the network update process, the processor is further disposed to: calculate to determine the current action based on the previous observation value according to the current policy of the model; when the environment receives the current action through the input/output interface, determine whether the success rate corresponding to the current state of the environment reaches the success rate threshold; and determine that the experience collection process reaches the termination condition in response to the success rate reaching the success rate threshold.

The disclosure provides an algorithm method for deep reinforcement learning, including initializing an environment and a model; executing an experience collection process and a network update process in parallel, and determining whether the experience collection process and the network update process have reached a termination condition; and continuing executing the experience collection process and the network update process in parallel in response to neither of the experience collection process and the network update processes has met the termination condition; and stopping executing the experience collection process and the network update process in response to one of the experience collection processes and the network update process having met the termination condition. The experience collection process includes obtaining a current state of the environment, wherein the current state includes a current reward value and a current observation value; calculating to determine the current action based on the current observation value according to a current policy of the model; and returning the current action to the environment. The network update process includes obtaining a previous state of the environment and a previous policy of the model, wherein the previous state includes a previous action, a previous reward value, and a previous observation value; calculating based on the previous state to determine current data; and updating the previous policy of the model to the current policy based on the current data.

Based on the above, the algorithm system for deep reinforcement learning and the algorithm method thereof in the present disclosure provide a solution that integrates training and inference. Through simultaneously executing experience collection and network updating in parallel, it is possible to effectively improve hardware utilization and reduce latency.

### BRIEF DESCRIPTION OF THE DRAWINGS

FIG. 1 is an architectural diagram of an algorithm system for deep reinforcement learning according to an embodiment of the present disclosure.

FIG. 2 is a flow chart of an algorithm method for deep reinforcement learning according to an embodiment of the present disclosure.

### DETAILED DESCRIPTION OF DISCLOSED EMBODIMENTS

Some embodiments of the present disclosure will be described in detail with reference to the accompanying drawings. The reference signs cited in the following description will be regarded as denoting the same or similar components when the same reference signs appear in different drawings. These embodiments are only part of the disclosure and do not disclose all possible implementations of the disclosure.

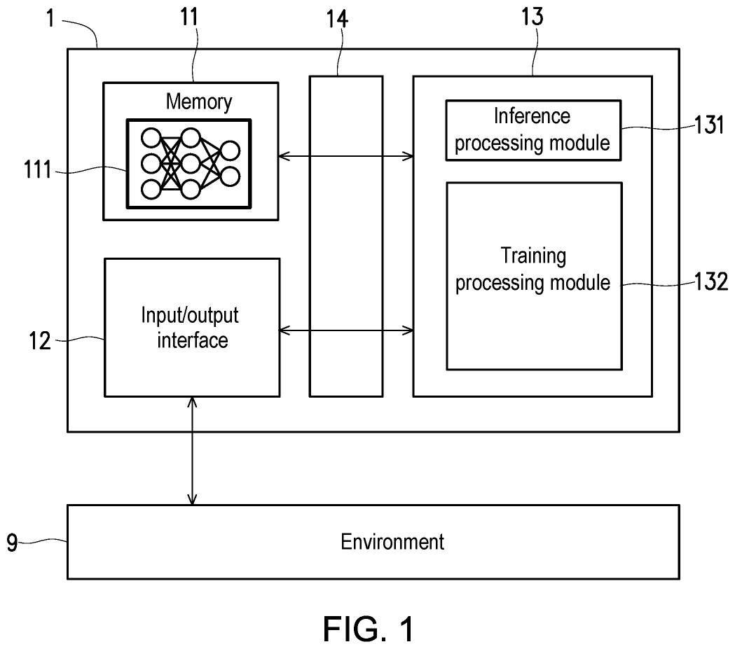

FIG. 1 is an architectural diagram of an algorithm system 1 for deep reinforcement learning according to an embodiment of the present disclosure. Please refer to FIG. 1. The algorithm system 1 for deep reinforcement learning includes a memory 11, an input/output interface 12, a processor 13 and a data transmission interface 14. Practically speaking, the algorithm system 1 for deep reinforcement learning may be implemented by computer devices, such as desktop computers, notebook computers, tablet computers, workstations and other computer devices with computing functions, display functions and networking functions. This disclosure is not limited thereto.

The memory 11 is disposed to store the previous state of the environment 9, the previous policy of the model 111, the inference program and the training program. Practically speaking, the memory 11 is, for example, a static random-access memory (SRAM), a dynamic random access memory (DRAM) or other memory, and the disclosure is not limited thereto.

The processor 13 is coupled to the memory 11 and the input/output interface 12 through the data transmission interface 14. Practically speaking, the processor 13 may be a central processing unit (CPU), a microprocessor or an embedded controller, and the disclosure is not limited thereto.

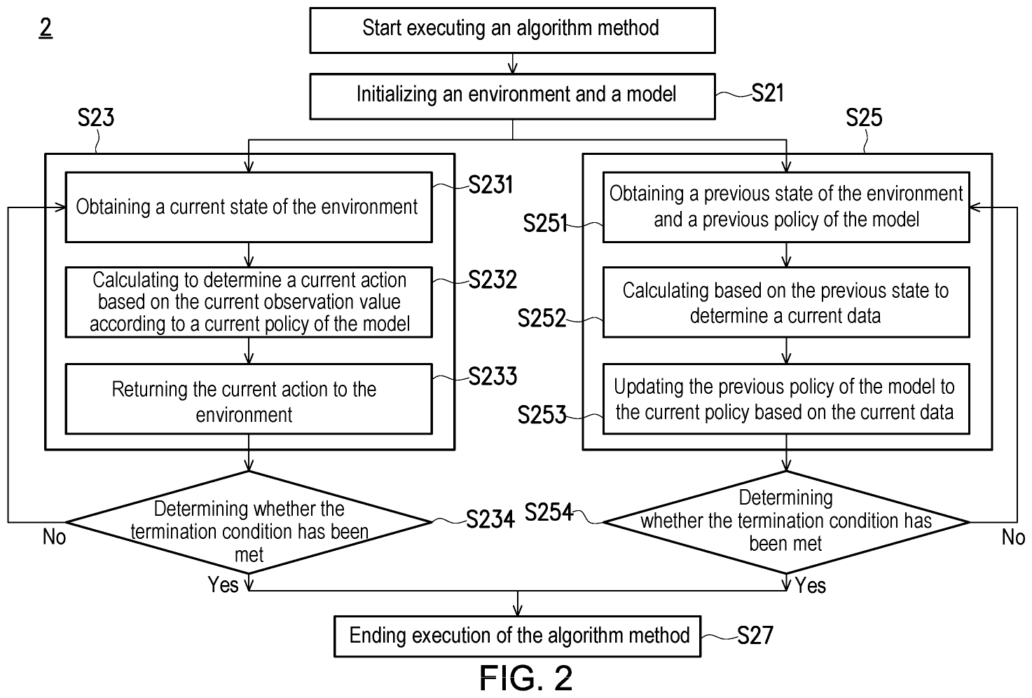

The processor 13 is disposed to execute the algorithm method for deep reinforcement learning. FIG. 2 is a flow chart of an algorithm method 2 for deep reinforcement learning according to an embodiment of the present disclosure. The algorithm method 2 in FIG. 2 may be executed by the processor 13 of the algorithm system 1 in FIG. 1. The algorithm method 2 for deep reinforcement learning includes steps S21, S23, S25, S27, S231 to S234, and S251 to S254. Next, please refer to FIG. 1 and FIG. 2 both for description of the algorithm method 2 for deep reinforcement learning. After the processor 13 starts executing the algorithm method 2, in step S21, the processor 13 initializes the environment 9 and the model 111 through the input/output interface 12.

After the processor 13 initializes the environment 9 and the model 111, the processor 13 reads the inference program and the training program from the memory 11. The inference program corresponds to the experience collection process, and the training program corresponds to the network update process. In the conventional algorithm method for deep reinforcement learning, the experience collection process involves evaluating the current state of the environment (including reward values and observation values) based on the policy of the current network model to determine the next action to be performed in the environment, and the network update process involves calculating based on the previous state (including actions, reward values, and observation values) data collected in the environment in the past to update the policy of the current network model.

After the processor 13 obtains the inference program and the training program from the memory 11, the processor 13 executes the experience collection process of step S23 and the network update process of step S25 in parallel. After the experience collection process of step S23 is executed once, the processor 13 will determine whether the experience collection process reaches the termination condition in step S234. Similarly, after the network update process of step S25 is executed once, the processor 13 will also determine whether the network update process reaches the termination condition in step S254.

In the conventional algorithm method for deep reinforcement learning, only one of the inference program and the training program can be executed at a time, and they cannot be executed simultaneously. The algorithm system 1 and its algorithm method 2 for deep reinforcement learning disclosed in the present disclosure may use the processor 13 to simultaneously execute the inference program and the training program in parallel to process experience collection and network updates in parallel. As long as the processor is able to perform parallel operations on different programs simultaneously, such processor may be adopted as the processor 13 of the algorithm system 1 for deep reinforcement learning disclosed in the present disclosure to execute the inference program and the training program in parallel.

In an embodiment, the processor 13 of the algorithm system 1 for deep reinforcement learning disclosed in the present disclosure may be a multi-tasking processor for executing the inference program and the training program simultaneously to process experience collection and network updates in parallel.

In another embodiment, the processor 13 of the algorithm system 1 for deep reinforcement learning disclosed in the present disclosure includes an inference processing module 131 and a training processing module 132. The inference processing module 131 is disposed to read the inference program from the memory and execute the experience collection process. The training processing module 132 is disposed to read the training program from the memory and execute the network update process.

In response to the experience collection process of step S23 and the network update process of step S25 not reaching the termination condition, the processor 13 continues to execute the experience collection process (steps S231 to S233) of step S23 and the network update process (steps S251 to S253) of step S25 in parallel. In response to one of the experience collection process of step S23 and the network update process of step S25 reaching the termination condition, in step S27, the processor 13 ends the execution experience collection process of step S23 and the network update process of step S25.

Next, the experience collection process of step S23 and the network update process of step S25 will be described separately. Although step S23 and step S25 will be described separately, the experience collection process of step S23 and the network update process of step S25 are executed in parallel by the processor 13.

First, the experience collection process of step S23 will be described. In step S231, the processor 13 obtains the current state of the environment 9 through the input/output interface 12. The current state includes the current reward value and the current observation value. After the processor 13 obtains the current state of the environment 9, in step S232, calculation is performed to determine the current action based on the current observation value according to the current policy of the model 111. Once the current action is determined, in step S233, the processor 13 returns the current action to the environment 9 through the input/output interface 12.

Next, in step S234, the processor 13 determines whether the experience collection process of step S23 reaches the termination condition. In an embodiment, the processor 13 determines whether the number of executions of the experience collection process in step S23 reaches an execution number threshold (for example: 10,000 times). If the processor 13 executes the experience collection process of step S23 less than 10,000 times, the experience collection process of step S23 is iteratively executed. In response to the execution number reaching the execution number threshold, the processor 13 determines that the experience collection process of step S23 reaches the termination condition. Once the experience collection process in step S23 reaches the termination condition, even if the network update process in step S25 has not yet reached the termination condition, the processor 13 will directly execute step S27 to end the execution of the algorithm method 2.

In another embodiment, when the environment 9 receives the current action determined in step S232 in the experience collection process through the input/output interface 12, the environment 9 will generate a new current state (i.e., the current reward value and the current observation value), the processor 13 determines whether the success rate corresponding to the current state of the environment 9 reaches the success rate threshold. In response to the success rate reaching the success rate threshold, the processor 13 determines that the experience collection process of step S23 reaches the termination condition. Once the experience collection process in step S23 reaches the termination condition, even if the network update process in step S25 has not yet reached the termination condition, the processor 13 will directly execute step S27 to end the execution of the algorithm method 2.

Next, the network update process of step S25 will be described. In step S251, the processor 13 obtains the previous state of the environment 9 and the previous policy of the model 111 from the memory 11. The previous state includes the previous action, the previous reward value, and the previous observation value. In particular, the term “previous” here means a time earlier than the term “current” on the timeline. In other words, the network update process in step S25 does not use the current state of the environment 9 and the ultimately decided current action obtained in the experience collection process in step S23, but uses the previous state already existed in the environment 9 and the previous policy of already existed in the model 111 before the processor 13 starts executing the experience collection process of step S23 and the network update process of step S25 in parallel.

In step S252, the processor 13 performs calculation based on previous state to determine the current data. In step S253, the processor 13 updates the previous policy of the model 111 to the current policy based on the current data.

Next, in step S254, the processor 13 determines whether the network update process in step S25 reaches the termination condition. In an embodiment, the processor 13 determines whether the number of executions of the network update process in step S25 reaches an execution number threshold (e.g., 10,000 times). If the processor 13 executes the network update process of step S25 less than 10,000 times, the network update process of step S25 is iteratively executed. In response to the number of executions reaching the execution number threshold, the processor 13 determines that the network update process in step S25 reaches the termination condition. Once the network update process in step S25 reaches the termination condition, even if the experience collection process in step S23 has not yet reached the termination condition, the processor 13 will directly execute step S27 to end the execution of the algorithm method 2.

In another embodiment, the processor 13 performs calculation to determine the current action of the environment 9 based on previous observation value according to the current strategy of the model 111. When the environment 9 receives the determined current action through the input/output interface 12, the environment 9 will generate a new current state (i.e., the current reward value and the current observation value), and the processor 13 determines whether the success rate corresponding to the current state of the environment 9 reaches the success rate threshold. In response to the success rate reaching the success rate threshold, the processor 13 determines that the network update process in step S25 reaches the termination condition. Once the network update process in step S25 reaches the termination condition, even if the experience collection process in step S23 has not yet reached the termination condition, the processor 13 will directly execute step S27 to end the execution of the algorithm method 2.

Based on the above, the algorithm system and its algorithm method for deep reinforcement learning of the present disclosure provide a solution that integrates training and inference. The processor executes the experience collection process and the network update process in parallel to simultaneously perform experience collection and network updates, thereby effectively improving hardware utilization and reduce latency.

What is claimed is:

1. An algorithm system for deep reinforcement learning, comprising:
a memory disposed to store a previous state of an environment, a previous policy of a model, an inference program, and a training program;
an input/output interface; and
a processor coupled to the memory and the input/output interface to:
perform initialization of the environment and the model through the input/output interface;
read the inference program and the training program from the memory, wherein the inference program corresponds to an experience collection process and the training program corresponds to a network update process;
execute the experience collection process and the network update process in parallel, and determine whether the experience collection process and the network update process meet a termination condition;
continue executing the experience collection process and the network update process in parallel in response to neither of the experience collection process and the network update processes has met the termination condition; and
stop executing the experience collection process and the network update process in response to one of the experience collection processes and the network update process having met the termination condition;
wherein the experience collection process comprises:
obtaining a current state of the environment through the input/output interface; wherein the current state comprises a current reward value and a current observation value;
calculating to determine a current action based on the current observation value according to a current policy of the model; and
returning the current action to the environment through the input/output interface; wherein the network update process comprises:
obtaining the previous state of the environment and the previous policy of the model from the memory, wherein the previous state comprises a previous action, a previous reward value, and a previous observation value;
calculating based on the previous state to determine a current data; and
updating the previous policy of the model to the current policy based on the current data.

2. The algorithm system for deep reinforcement learning according to claim 1, wherein the processor further comprises:
an inference processing module disposed to read the inference program from the memory and execute the experience collection process; and
a training processing module disposed to read the training program from the memory and execute the network update process.

3. The algorithm system for deep reinforcement learning according to claim 1, wherein when the processor executes the experience collection process, the processor is further disposed to:
determine whether the number of executions of the experience collection process reaches an execution number threshold; and
determine that the experience collection process reaches the termination condition in response to the number of the executions reaching the execution number threshold.

4. The algorithm system for deep reinforcement learning according to claim 1, wherein when the processor executes the network update process, the processor is further disposed to:
determine whether the number of executions of the network update process reaches an execution number threshold; and
determine that the network update process reaches the termination condition in response to the number of the executions reaching the execution number threshold.

5. The algorithm system for deep reinforcement learning according to claim 1, wherein when the processor executes the experience collection process, the processor is further disposed to:
after the environment receives the current action through the input/output interface, determine whether a success rate corresponding to the current state of the environment reaches a success rate threshold; and
determine that the experience collection process reaches the termination condition in response to the success rate reaching the success rate threshold.

6. The algorithm system for deep reinforcement learning according to claim 1, wherein when the processor executes the network update process, the processor is further disposed to:
calculate to determine the current action based on the previous observation value according to the current policy of the model;
when the environment receives the current action through the input/output interface, determine whether a success rate corresponding to the current state of the environment reaches a success rate threshold; and
determine that the experience collection process reaches the termination condition in response to the success rate reaching the success rate threshold.

7. An algorithm method for deep reinforcement learning, comprising:
initializing an environment and a model;
executing an experience collection process and a network update process in parallel, and determining whether the experience collection process and the network update process have reached a termination condition,
continuing executing the experience collection process and the network update process in parallel in response to neither of the experience collection process and the network update processes has met the termination condition; and
stopping executing the experience collection process and the network update process in response to one of the experience collection processes and the network update process having met the termination condition;
wherein the experience collection process comprises:
obtaining a current state of the environment, wherein the current state comprises a current reward value and a current observation value;
calculating to determine a current action based on the current observation value according to a current policy of the model; and
returning the current action to the environment;
wherein the network update process comprises:
obtaining a previous state of the environment and a previous policy of the model, wherein the previous state comprises a previous action, a previous reward value, and a previous observation value;
calculating based on the previous state to determine a current data; and
updating the previous policy of the model to the current policy based on the current data.

8. The algorithm method for deep reinforcement learning according to claim 7, wherein the step of determining whether the experience collection process has reached the termination condition further comprises:
determining whether the number of executions of the experience collection process reaches an execution number threshold; and
determining that the experience collection process reaches the termination condition in response to the number of the executions reaching the execution number threshold.

9. The algorithm method for deep reinforcement learning according to claim 7, wherein the step of determining whether the experience collection process has reached the termination condition further comprises:
after the environment receives the current action, determining whether a success rate corresponding to the current state of the environment reaches a success rate threshold;
determining that the experience collection process reaches the termination condition in response to the success rate reaching the success rate threshold.

10. The algorithm method for deep reinforcement learning according to claim 7, wherein the step of determining whether the network update process has reached the termination condition further comprises:
determine whether the number of executions of the network update process reaches an execution number threshold; and
determine that the network update process reaches the termination condition in response to the number of the executions reaching the execution number threshold.

11. The algorithm method for deep reinforcement learning according to claim 7, wherein the step of determining whether the network update process has reached the termination condition further comprises:
calculating to determine the current action based on the previous observation value according to the current policy of the model; and
when the environment receives the current action, determining whether a success rate corresponding to the current state of the environment reaches a success rate threshold;
determining that the experience collection process reaches the termination condition in response to the success rate reaching the success rate threshold.
